(19) United States
(12) Patent Application Publication
(10) Pub. No.: US 2026/0259644 A1
(43) Pub. Date: Sep. 3, 2026

(54) INTERACTION METHOD, INTERACTION SYSTEM, AND ELECTRONIC DEVICE

(71) Applicant: Lenovo (Beijing) Limited, Beijing (CN)

(72) Inventors: Litong XIAO, Beijing (CN); Hanliu CHEN, Beijing (CN)

(21) Appl. No.: 19/542,776

(22) Filed: Feb. 18, 2026

(30) Foreign Application Priority Data
Feb. 28, 2025 (CN) 202510240411.6

(51) Int. Cl. G06F 3/0484; G06F 9/451

(52) U.S. Cl. CPC G06F 3/0484; G06F 9/453

(57) ABSTRACT

An interaction method includes displaying interactive information on a first interface. The interactive information at least includes first information input by a user and second information generated by an agent based on the first information. The method further includes determining one or more map nodes based on the interactive information and generating an interactive information map based on the one or more map nodes. The information map is displayed on a second interface. The method also includes, in response to an operation on the first interface or the second interface, updating the interactive information map and the interactive information on the first interface. The first interface and the second interface have relatively independent display areas that are able to adaptively scale based on displayed content.

### CROSS-REFERENCE TO RELATED APPLICATION

This application claims priority to Chinese Patent Application No. 202510240411.6, filed on February 28, 2025, the entire contents of which are incorporated herein by reference.

### TECHNICAL FIELD

The present disclosure generally relates to the field of artificial intelligence technologies, and, more particularly, to an interaction method, an interaction system, and an electronic device.

### BACKGROUND

As artificial intelligence (AI) technology develops, especially with the widespread application of intelligent agents and large model technologies, a large number of AI-based chat applications emerge and are widely used in various fields. However, most existing interaction methods are based on linear text, which has many limitations when dealing with complex problems.

### SUMMARY

In accordance with the disclosure, there is provided an interaction method including displaying interactive information on a first interface. The interactive information at least includes first information input by a user and second information generated by an agent based on the first information. The method further includes determining one or more map nodes based on the interactive information and generating an interactive information map based on the one or more map nodes. The information map is displayed on a second interface. The method also includes, in response to an operation on the first interface or the second interface, updating the interactive information map and the interactive information on the first interface. The first interface and the second interface have relatively independent display areas that are able to adaptively scale based on displayed content.

Also in accordance with the disclosure, there is provided an electronic device including one or more processors, and one or more memories storing executable instructions that, when executed by the one or more processors, cause the electronic device to display interactive information on a first interface. The interactive information at least includes first information input by a user and second information generated by an agent based on the first information. The instructions further cause the electronic device to determine one or more map nodes based on the interactive information and generate an interactive information map based on the one or more map nodes. The information map is displayed on a second interface. The instructions also cause the electronic device to, in response to an operation on the first interface or the second interface, update the interactive information map and the interactive information on the first interface. The first interface and the second interface have relatively independent display areas that are able to adaptively scale based on displayed content.

Also in accordance with the disclosure, there is provided a non-transitory computer-readable storage medium storing instructions that, when executed by a processor, cause an electronic device including the processor to display interactive information on a first interface. The interactive information at least includes first information input by a user and second information generated by an agent based on the first information. The instructions further cause the electronic device to determine one or more map nodes based on the interactive information and generate an interactive information map based on the one or more map nodes. The information map is displayed on a second interface. The instructions also cause the electronic device to, in response to an operation on the first interface or the second interface, update the interactive information map and the interactive information on the first interface. The first interface and the second interface have relatively independent display areas that are able to adaptively scale based on displayed content.

### BRIEF DESCRIPTION OF THE DRAWINGS

FIG. 1 is a schematic diagram showing an application scenario of an interaction system consistent with embodiments of the present disclosure.

FIG. 2 is a flow chart of an interaction method consistent with embodiments of the present disclosure.

FIG. 3 is a flow chart of a method for generating an information map consistent with embodiments of the present disclosure.

FIG. 4 is a schematic diagram showing an interactive information map consistent with embodiments of the present disclosure.

FIG. 5 is a flow chart of a dynamic updating process of an information map consistent with embodiments of the present disclosure.

FIG. 6 is another flow chart of a dynamic updating process of an information map consistent with embodiments of the present disclosure.

FIG. 7 is a schematic diagram showing a synchronized updating process of a first interface and a second interface consistent with embodiments of the present disclosure.

FIG. 8 is a schematic diagram showing an interaction interface consistent with embodiments of the present disclosure.

FIG. 9 is a schematic structural diagram of an interaction system consistent with embodiments of the present disclosure.

FIG. 10 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The embodiments in the present disclosure are only used to describe the present disclosure and are not intended to limit the scope of the present disclosure. It is understandable that other embodiments obtained by those skilled in the art in the absence of inventive effort are within the scope of the present disclosure. In the following detailed description, numerous specific details are set forth to provide a thorough understanding of the embodiments of the present disclosure for ease of explanation. However, it will be apparent that one or more embodiments may be implemented without these specific details. Furthermore, descriptions of well-known structures and technologies are omitted in the following description to avoid unnecessarily obscuring the concepts of the present disclosure.

In the technical solutions of the present disclosure, the acquisition, storage, and application of user personal information comply with relevant laws and regulations, necessary confidentiality measures are taken, and they do not violate public order and good morals. In the technical solutions of the present disclosure, the acquisition, collection, storage, use, processing, transmission, provision, disclosure, and application of data comply with relevant laws and regulations, necessary confidentiality measures are taken, and they do not violate public order and good morals.

The terminology used herein is merely for describing specific embodiments and is not intended to limit the scope of the present disclosure. The terms “comprising,” “including,” etc., as used herein, indicate the presence of features, steps, operations, and/or components, but do not exclude the presence or addition of one or more other features, steps, operations, or components.

When expressions such as “at least one of A, B, or C” are used, it should generally be interpreted in accordance with the meaning commonly understood by those skilled in the art (e.g., “a system having at least one of A, B, or C” may include, but is not limited to, systems having A alone, having B alone, having C alone, having A and B, having A and C, having B and C, and/or having A, B, and C, etc.). The terms “first”, “second”, etc., are used for descriptive purposes only and should not be construed as indicating or implying relative importance or implicitly specifying the number of technical features indicated. Thus, features defined with “first”, “second”, etc., may explicitly or implicitly include one or more features.

In IT problem diagnosis applications, user interaction with an intelligent agent is mostly linear and chat-style text-based. This chat-style interaction requires users to answer numerous questions, leading to multiple rounds of interaction during the diagnostic process. Users become resistant after answering more than three questions, resulting in a poor user experience. Reducing the number of questions leads to a lack of key data, affecting diagnostic accuracy. The returned information is mostly textual descriptions, and users may not have the patience to read through too much content. Even when converted to voice, the playback time is extended, still impacting the user experience. IT diagnosis involves numerous branching possibilities. Current products often provide a back button option for users to choose from. Because chat is sequential, switching to other diagnostic branches requires manual backtracking, resulting in a poor user experience.

The present disclosure provides an interaction method to at least partially alleviate the above problems. The method may include: displaying interactive information on a first interface, where the interactive information at least includes first information input by a user and second information generated by an agent based on the first information; determining map nodes according to the interactive information and generating an interactive information map based on the map nodes, where the information map is displayed on a second interface; and updating the interactive information map and the interactive information on the first interface in response to an operation on the first interface or the second interface. The first interface or the second interface may have relatively independent display areas, and the display areas may adaptively scale based on the displayed content.

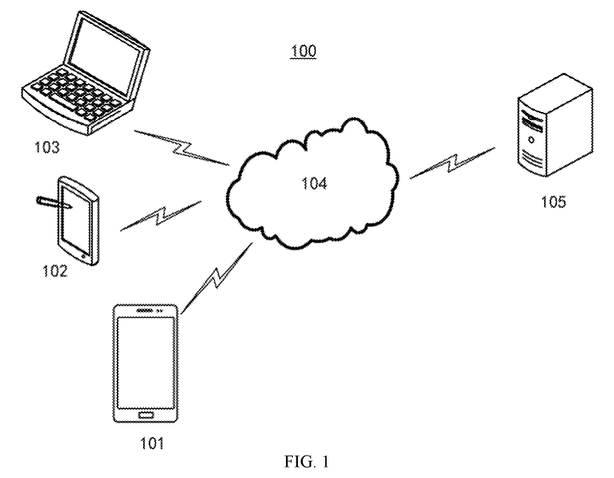

In one embodiment, shown in FIG. 1, which is a schematic diagram showing an application scenario of an interactive system according to the present disclosure, an application scenario 100 may be an IT (Information Technology) problem diagnosis scenario, and may also be applied to other scenarios requiring complex decision-making, multi-branch process management, and user interaction, such as medical diagnosis, educational tutoring, enterprise decision-making, or customer service technical support. A network 104 serves as a medium for providing a communication link between a first terminal device 101, a second terminal device 102, a third terminal device 103, and a server 105. The network 104 may include various connection types, such as wired or wireless communication links, or fiber optic cables.

A user may use the first terminal device 101, the second terminal device 102, or the third terminal device 103 to interact with the server 105 through the network 104 to receive or send information, etc. Various communication client applications may be installed on the first terminal device 101, the second terminal device 102, or the third terminal device 103, such as shopping applications, web browser applications, search applications, instant messaging tools, email clients, social media platform software, etc.

The first terminal device 101, the second terminal device 102, and the third terminal device 103 may be various electronic devices with displays and supporting web browsing, including but not limited to smartphones, tablets, laptops, desktop computers, etc.

The server 105 may be a server that provides various services to the interaction system, such as a backend server that automatically generates reply information based on the information entered by the user using the first terminal device 101, the second terminal device 102, and the third terminal device 103 (this is just an example). The backend server may process the received input information through semantic analysis or other techniques, invoke multiple agents to automatically generate response information related to the question, and then provide the response information to the terminal device in a graphical interactive format.

It should be noted that the interaction method provided in this embodiment may generally be executed by the server 105. Correspondingly, the interaction system provided in this embodiment may generally be located in the server 105. In some other embodiments, the interaction method may also be executed by a server or a server cluster that is different from server 105 and capable of communicating with the first terminal device 101, the second terminal device 102, the third terminal device 103, and/or the server 105. Correspondingly, the interaction system may be located in a server or a server cluster that is different from server 105 and capable of communicating with the first terminal device 101, the second terminal device 102, the third terminal device 103, and/or the server 105.

The number of terminal devices, networks, and servers in FIG. 1 is merely illustrative. Any number of terminal devices, networks, and servers may be used, depending on implementation needs, in various embodiments of the present disclosure.

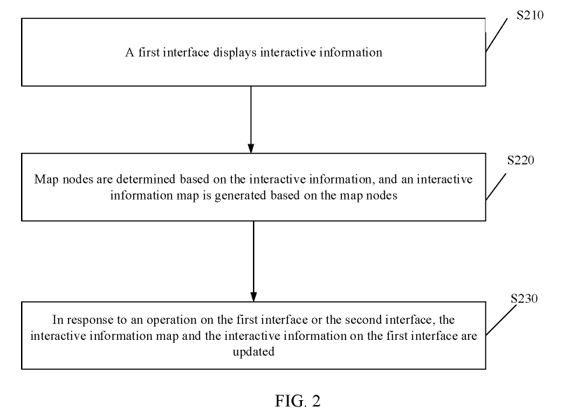

The interaction method provided by the present disclosure will be described in detail below based on the scenario described in FIG. 1, using FIGS. 2 to 8.

In one embodiment shown in FIG. 2, which is a flowchart of the interaction method according to the present disclosure, the interaction method may include S210 to S230.

At S210, a first interface displays interactive information.

In one embodiment, the interactive information may include at least first information input by a user and second information generated by an intelligent agent based on the first information.

At S220, map nodes are determined based on the interactive information, and an interactive information map is generated based on the map nodes.

In one embodiment, the information map may be displayed on a second interface.

In one example, the first interface may serve as a chat dialogue area, used to display the dialogue information between the user and the AI intelligent agent, i.e., the interactive information. The interactive information may include initial information input by the user. In one embodiment, taking an IT problem diagnosis scenario as an example, the initial information may be an IT-related problem encountered by the user while using a device, such as why the computer is lagging or why the screen is displaying a blue screen. It should be understood that the data type of the initial information may include, but is not limited to, text data, voice data, image data, or video data, etc., which is not specifically limited in the present disclosure. For example, the user may input the initial information through any terminal device on the first interface.

In some other embodiments, the interactive information may also include the second information generated by the intelligent agent based on the initial information. For example, after receiving the initial information input by the user, the background system may call one or more intelligent agents to generate and execute tasks such as problem definition, intent recognition, or content generation to generate response information, i.e., the second information, and display the second information in the chat dialog box on the first interface.

In one embodiment, to solve the interactive experience problem in complex tree-structured IT diagnosis scenarios and allow users to more intuitively understand the diagnostic path and branches, the interactive information map may also be generated based on the interactive information during the user’s interaction with the AI intelligent agent, and this information map may be displayed on the second interface. The user may intuitively understand the interaction process through the interactive information map, quickly select the desired operation path, and avoid the problems of backtracking difficulties and low interaction efficiency caused by linear interaction in related technologies.

At S230, in response to an operation on the first interface or the second interface, the interactive information map and the interactive information on the first interface are updated.

In one embodiment, the first interface and the second interface may have relatively independent display areas, and the display areas may be adaptively scaled based on displayed content.

In one embodiment, the first interface and the second interface may have relatively independent display areas, and they may be updated in tandem. For example, during the interaction, the user may perform an operation on either the first interface or the second interface, thereby synchronously triggering the update of the interactive information in the first interface and the interactive information map in the second interface. As the interaction progresses, the information map structure may become increasingly larger. To improve interaction efficiency and user experience, the display areas may be adaptively scaled based on the displayed content, ensuring that the user always has a good interactive experience. The layout of the first interface and the second interface may be pre-configured according to user needs and preferences, which may be a left-right layout, a top-bottom layout, or a nested layout.

In some embodiments, the interactive information may be displayed on the first interface, and the interactive information map may be generated on the second interface based on the interactive information. When an operation is performed on either the first interface or the second interface, the interactive information map and the interactive information may be updated in real time. By combining graphical and text-based interaction, the user may intuitively understand the interaction process through the interactive information map and quickly select the desired operation path, avoiding the problems of difficult backtracking and low interaction efficiency caused by linear interaction in related technologies. Dynamic display and real-time updating of the information map may enhance the intuitiveness and real-time nature of the interaction. The visual structure of the information map may enable users to quickly locate problems, improving the user experience.

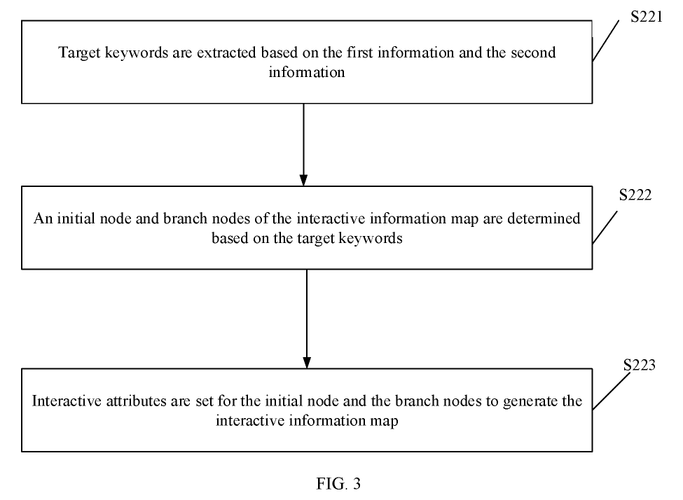

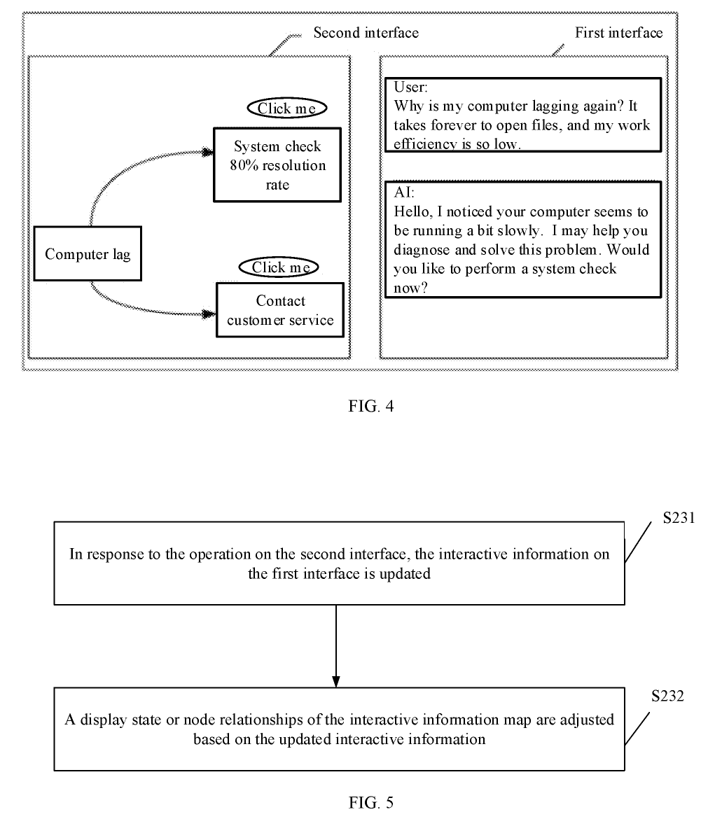

The generation process of the information map according to an embodiment of the present disclosure will be described below with reference to FIG. 3 and FIG. 4, where FIG. 3 is a flowchart of an information map generation method according to an embodiment of the present disclosure and FIG. 4 is a schematic diagram showing an interactive information map generated according to an embodiment of the present disclosure.

As shown in FIG. 3, S220 includes S221 to S223.

At S221, target keywords are extracted based on the first information and the second information.

At S222, an initial node and branch nodes of the interactive information map are determined based on the target keywords.

At S223, interactive attributes are set for the initial node and the branch nodes to generate the interactive information map.

In one embodiment, setting the interactive attributes for the initial node and the branch nodes may include: setting at least one interactive function for the initial node and the branch nodes, where the at least one interactive function is used to implement operations on the map nodes; and setting an association relationship between the initial node or the branch nodes and the interactive information of the first interface.

In one embodiment, the at least one interactive function may include one or more of clicking, dragging, expanding, or collapsing; and the association relationship between the initial node or the branch nodes and the interactive information of the first interface may be set.

For example, as shown in FIG. 4, the user enters the first information on the first interface: “Why is my computer lagging again? It takes forever to open files, and my work efficiency is so low.” Based on this first information, the AI agent automatically replies with the second information: “Hello, I noticed your computer seems to be running a bit slowly. I may help you diagnose and solve this problem. Would you like to perform a system check now?” The target keywords “computer lag,” “system check,” and “contact customer service” may be extracted as the map nodes based on the first information and the second information. These map nodes may include the initial node and the branch nodes. The initial node may be related to the topic of the user’s input problem. For example, the initial node keyword may be “computer lag.” Since the AI agent’s solution for computer lag may be a system check or contacting customer service, “system check” or “contact customer service” may be determined as the keywords for the branch nodes. In the current chat scenario, the AI agent may determine during the interaction whether the problem is context-dependent or deviates from the current interaction. When creating a new problem, based on the new problem, a new initial node may be generated in the map. For example, when a user enters a new question, a new initial node may be generated based on the keywords of the new question. For example, when the user enters “Why is my monitor blue-screening?”, the initial node may be “Monitor blue-screening”. Determining whether a question is new based on the interaction context is a common technique in existing intelligent agent-based methods, and will not be limited here.

For example, after determining the map nodes, the interactive attributes may be set for the initial node and the branch nodes, ensuring that each node has at least one interactive function. The at least one interactive function may include one or more of click, drag, expand, or collapse. For example, the initial node may have drag and expand/collapse interactive functions, and different branch nodes may have different interactive functions. To further enhance the user’s understanding of the map in the second interface and improve its interactivity, the relationship may be established between the initial node or the branch nodes and the interactive information in the first interface. When the user interacts with a node on the map, the corresponding description may be simultaneously displayed in the first interface. For example, “system check is performing, I will obtain the description currently displayed in the first interface for that node” may be displayed. When the user clicks the system check node, the device’s operating status will be checked, and factors that might cause system slowdown will be inferred.”

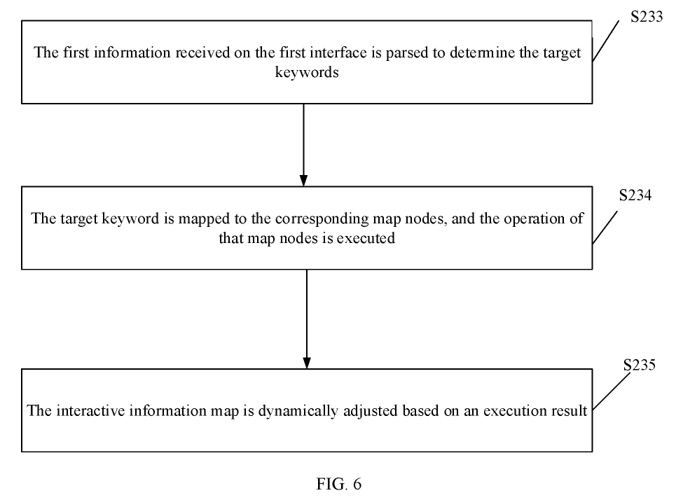

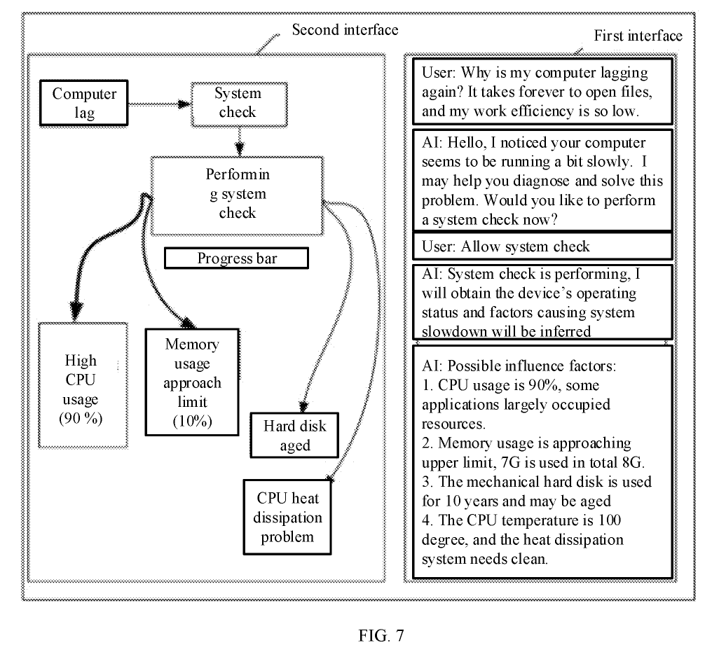

In some embodiments of the present disclosure, any operation by the user on either the first interface or the second interface may trigger a synchronized update of the information map and interactive information. The specific interaction process will be described below with reference to FIG. 5 to FIG. 7, where FIG. 5 is a flowchart of the dynamic update process of the information map according to an embodiment of the present disclosure, FIG. 6 is another flowchart of the dynamic update process of the information map according to an embodiment of the present disclosure, and FIG. 7 is a schematic diagram showing the synchronized update of the first and second interfaces provided according to an embodiment of the present disclosure.

As shown in FIG. 5, S230 includes S231 and S232.

At S231, in response to the operation on the second interface, the interactive information on the first interface is updated.

At S232, a display state or node relationships of the interactive information map are adjusted based on the updated interactive information.

In one embodiment, any operation by the user on either the first interface or the second interface may trigger the update of the information map and interactive information. Taking the operation on the second interface as an example, the system may respond to the user’s operation command, identify the user’s operation intent, update the interaction record, and thus update the interactive information map. Operations on the second interface may typically include interactive operations on nodes, such as clicking, dragging, expanding, etc., or information input operations such as filling in information and submitting a form at a node.

For example, as shown in FIG. 7, when the user selects the system check operation, they may click the system check node button in the information map on the second interface. That is, the input of the first information by the user may be executed not only through the first interface but also by the user’s operation on the second interface. In response to the user’s click operation on the second interface, the system may change the interactive information context according to the user’s operation intent, and synchronously update the interactive information on the first interface, i.e., “User: Allow system check”. When the backend system recognizes the change in interactive information context, it may re-trigger the comprehensive diagnosis and system check process based on the updated interactive information. Simultaneously, it may dynamically adjust and update the display status or node relationships of the interactive information map, such as displaying a progress bar in real time based on the execution progress. It should be understood that the interactive information map may also be automatically updated based on the execution results of the backend system. For example, new-level branch nodes may be determined based on the system check results. For example, when the check results show that the computer lag is caused by high CPU usage, memory usage nearing its limit, aging of the mechanical hard drive, or CPU overheating, these newly generated branch nodes may be updated and displayed in the interactive information map.

As shown in FIG. 6, in one embodiment, S230 also includes S233, S234, and S235.

At S233, the first information received on the first interface is parsed to determine the target keywords.

At S234, the target keyword is mapped to the corresponding map node, and the operation of that map node is executed.

At S235, the interactive information map is dynamically adjusted based on an execution result.

In some other embodiments, the user may also update the information map through operations on the first interface. For example, as shown in FIG. 7, the user may enter the first information “Allow system check” in the input box of the chat dialog area on the first interface, or execute “Allow user to perform system check” by clicking the node on the second interface. The system may parse and identify the keywords or instructions in the first information, determine the target keyword “system check”, and assign “Allow system check” as an operation instruction to the corresponding node of the interactive information map. The operation of the system check node may be executed, and the interactive information map may be dynamically adjusted based on the execution result. The update process of the interactive information map may be similar to S232, and will not be repeated here.

In some embodiments, a node backtracking function may be further provided, allowing the user to return to the previous level node of the information map through operation. Also, a global view function may be further provided, allowing the user to view the global structure of the information map through operation.

For example, in one embodiment, the node backtracking function may be provided, allowing users to return to a previous node in the map through specific actions, such as clicking a button, using voice commands, or performing specific gestures. Optionally, users may also select nodes based on their interaction history, enabling them to return to previous node states and related information within the interactive map, ensuring seamless continuation of previous interactions. Using the map shown in FIG. 7 as an example, users may choose to revert from the system check node to the initial node and reselect the “Contact After-Sales Service” node to resolve the current issue. Such operations may be triggered by the user entering initial information on the first interface or by interacting with nodes on the second interface.

For another example, the global view function may be provided, allowing users to view the overall structure of the map through specific actions, such as clicking the global view button, zooming, or using voice commands. This may help users quickly understand the overall interaction path and branching, improving transparency and user experience.

In some embodiments, a short-term memory erasure function may also be provided to clear temporary operation records of user interactions with the map or dialog boxes, allowing users to restart interactions or return to a specific interaction node. For example, the interface may provide a “Clear History” or “Reset” button. Clicking this button may clear the current interaction history. Users may also return to a specific node and clear all records after that node.

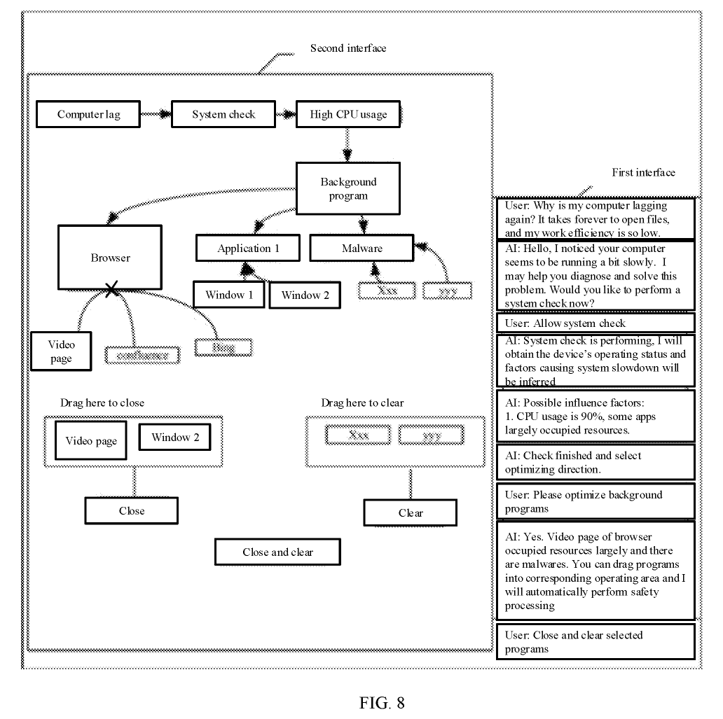

FIG. 8 is a schematic diagram showing an interactive interface according to an embodiment of the present disclosure.

In one embodiment of the present disclosure, prompts may be set on the first interface or the second interface to guide user interaction; and execution progress may be displayed on the first interface or the second interface.

In one embodiment of the present disclosure, target nodes may be highlighted, and other nodes may be hidden or faded. The target nodes may include the currently executing node and its associated nodes.

As shown in FIG. 8, prompts for guiding user interaction may be set on the interface. The prompts may include prompts guiding user clicks, dragging, or input. When a user clicks a map node, a progress bar may be displayed to show the execution progress. Different nodes may be displayed in different colors. When a user clicks on a branch node, such as a background program, the background program node in the information map may be highlighted, along with its associated nodes. The associated nodes may include the background program node’s next-level branch nodes. Other branch nodes at the same level and other upper-level historical nodes may be automatically hidden or faded, and the nodes may become smaller and lighter in color.

In one example, when influence factor analysis is being performed, the node sizes may be displayed based on the weight of the influence results. Larger nodes may indicate a higher probability, and the connections between nodes may be thicker. As shown in FIG. 8, the browser causing system lag may be the most significant factor, such that this node is displayed at its largest size. As the interaction progresses, the information map content may increase, and the tree structure may become more divergent. At this point, the display area of the second interface may adaptively enlarge based on its content, while simultaneously shrinking the display area of the first interface, ensuring a consistently good user experience. After multiple rounds of interaction, after the user selects an optimization solution, the second interface may simultaneously display other optimization routes for the user to choose from, showcasing corresponding solutions. When the solution involves other services, operable buttons may be further displayed for the user to select.

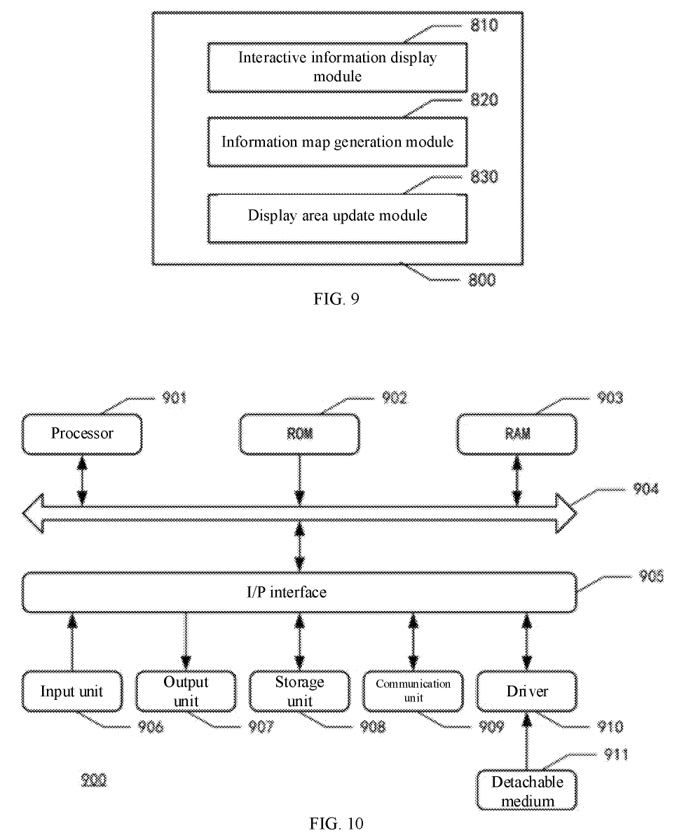

The present disclosure also provides an interactive system. The system will be described in detail below with reference to FIG. 9.

In one embodiment, as shown in FIG. 9, which is a structural block diagram of an interactive system according to an embodiment of the present disclosure, the interactive system 800 includes an interactive information display module 810, an information map generation module 820, and a display area update module 830.

The interactive information display module 810 may be configured to display interactive information on a first interface. The interactive information may include at least first information input by the user and second information generated by the agent based on the first information. In one embodiment, the interactive information display module 810 may be used to perform S210 described above, which will not be repeated here.

The information map generation module 820 may be configured to determine map nodes based on the interactive information and generate an interactive information map based on the map nodes. The information map may be displayed on a second interface. In one embodiment, the information map generation module 820 may be used to perform S220 described above, which will not be repeated here.

The display area update module 830 may be configured to update the interactive information map and the interactive information on the first interface in response to an operation on the first interface or the second interface. In one embodiment, the display area update module 830 may be used to perform S230 described above, which will not be repeated here.

One or more modules of the interactive information display module 810, the information map generation module 820, and the display area update module 830 may be merged into one module, or any one of these modules may be split into multiple modules. Alternatively, at least part of the functionality of one or more of these modules may be combined with at least part of the functionality of other modules and implemented as one module. At least one of the interactive information display module 810, the information map generation module 820, and the display area update module 830 may be at least partially implemented as hardware circuitry, such as a field-programmable gate array (FPGA), a programmable logic array (PLA), a system-on-a-chip, a system-on-a-substrate, a system-on-package, an application-specific integrated circuit (ASIC), or implemented in hardware or firmware by any other reasonable means of integrating or packaging the circuitry, or implemented in any one of the three implementation methods of software, hardware, and firmware, or in a suitable combination of any of these. Alternatively, at least one of the interactive information display module 810, the information map generation module 820, and the display area update module 830 may be at least partially implemented as a computer program module, which, when run, can perform corresponding functions.

The present disclosure also provides an electronic device, suitable for implementing an interactive method according to any embodiment of the present disclosure.

In one embodiment, as shown in FIG. 10, which is a block diagram of an electronic device according to an embodiment of the present disclosure, the electronic device 900 includes a processor 901, which is configured to perform various appropriate actions and processes according to a program stored in a read-only memory (ROM) 902 or a program loaded from a storage unit 908 into a random access memory (RAM) 903. The processor 901 may include, for example, a general-purpose microprocessor (e.g., a CPU), an instruction set processor and/or an associated chipset and/or a special-purpose microprocessor (e.g., an application-specific integrated circuit (ASIC)), etc. The processor 901 may also include onboard memory for caching purposes. The processor 901 may include a single processing unit or multiple processing units for performing different actions of the method flow according to any embodiment of the present disclosure.

Various programs and data required for the operation of the electronic device 900 may be stored in RAM 903. The processor 901, ROM 902, and RAM 903 may be interconnected via a bus 904. The processor 901 may be configured to perform various operations of the method flow according to embodiments of the present disclosure by executing the program in ROM 902 and/or RAM 903. It should be noted that the program may also be stored in one or more memories other than ROM 902 and RAM 903. The processor 901 may also be configured to perform various operations of the method flow according to embodiments of the present disclosure by executing programs stored in one or more memories.

The electronic device 900 may further include an input/output (I/O) interface 905, which is also connected to the bus 904. The electronic device 900 may further include one or more of the following components connected to the input/output (I/O) interface 905: an input unit 906 including a keyboard, mouse, etc.; an output unit 907 including a cathode ray tube (CRT), liquid crystal display (LCD), etc., and a speaker, etc.; a storage unit 908 including a hard disk, etc.; and a communication unit 909 including a network interface card such as a LAN card, modem, etc. The communication unit 909 may be configured to perform communication processing via a network such as the Internet. A driver 910 may also be connected to the input/output (I/O) interface 905 as needed. A detachable medium 911, such as a disk, an optical disk, a magneto-optical disk, a semiconductor memory, etc., may be installed on the driver 910 as needed so that computer programs read from them may be installed into the storage unit 908 as needed.

The present disclosure also provides a computer-readable storage medium. The storage medium may be included in the device/apparatus/system described in the above embodiments, or it may exist independently and not be assembled into the device/apparatus/system. The computer-readable storage medium may be configured to store one or more programs that, when executed, implement the method according to any embodiments of the present disclosure.

Thee computer-readable storage medium may be a non-volatile computer-readable storage medium, including but not limited to: portable computer disks, hard disks, random access memory (RAM), read-only memory (ROM), erasable programmable read-only memory (EPROM or flash memory), portable compact disk read-only memory (CD-ROM), optical storage devices, magnetic storage devices, or any suitable combination thereof. The computer-readable storage medium may be any tangible medium that includes or stores a program that can be used by or in conjunction with an instruction execution system, apparatus, or device. For example, the computer-readable storage medium may include ROM 902 and/or RAM 903 and/or one or more memories other than ROM 902 and RAM 903 described above.

The present disclosure also provides a computer program product including a computer program. The computer program may include program code for performing the methods provided by any embodiments of the present disclosure. When the computer program product is run on a computer system, the program code may enable the computer system to implement the interactive methods provided by any embodiments of the present disclosure.

When the computer program is executed by the processor 901, the processor 901 may perform the functions defined in the system/apparatus of the embodiments of the present disclosure. The systems, apparatuses, modules, units, etc., described above may be implemented by computer program modules.

The computer program may rely on tangible storage media such as optical storage devices or magnetic storage devices. In another embodiment, the computer program may also be transmitted and distributed in the form of signals over a network medium and downloaded and installed via the communication unit 909, and/or installed from the detachable medium 911. The program code included in the computer program may be transmitted using any suitable network medium, including but not limited to: wireless, wired, etc., or any suitable combination thereof.

In one embodiment, the computer program may be downloaded and installed from a network via the communication unit 909, and/or installed from the detachable medium 911. When the computer program is executed by the processor 901, the processor 901 may perform the functions defined in the system/apparatus of the embodiments of the present disclosure. The systems, apparatuses, modules, units, etc., described above may be implemented by computer program modules.

The program code for executing the computer program provided in the embodiments of the present disclosure may be written in any combination of one or more programming languages. For example, the computer program may be implemented using high-level procedural and/or object-oriented programming languages, and/or assembly/machine languages. Programming languages include, but are not limited to, languages such as Java, C++, Python, C, or similar programming languages. The program code may be executed entirely on the user’s computing device, partially on the user’s device, partially on a remote computing device, or entirely on a remote computing device or server. In cases involving remote computing devices, the remote computing devices may be connected to the user’s computing device via any type of network, including a local area network (LAN) or a wide area network (WAN), or they may be connected to an external computing device (e.g., via the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in a flowchart or block diagram may represent a module, segment, or portion of code containing one or more executable instructions for implementing a specified logical function. It should also be noted that in some alternative implementations, the functions indicated in the blocks may occur in a different order than those indicated in the drawings. For example, two consecutively indicated blocks may actually be executed substantially in parallel, and they may sometimes be executed in reverse order, depending on the functions involved. It should also be noted that each block in a block diagram or flowchart, and combinations of blocks in a block diagram or flowchart, may be implemented using a dedicated hardware-based system that performs the specified function or operation, or using a combination of dedicated hardware and computer instructions.

Those skilled in the art will understand that the features described in the various embodiments of the present disclosure can be combined and/or combined in various ways, even if such combinations are not explicitly described in the present disclosure. The features described in the various embodiments of the present disclosure can be combined and/or combined in various ways without departing from the scope of the present disclosure. All such combinations and/or combinations fall within the scope of the present disclosure.

The embodiments of the present disclosure have been described above. However, these embodiments are for illustrative purposes only and are not intended to limit the scope of the present disclosure. Although various embodiments have been described above, this does not mean that the measures in the various embodiments cannot be used advantageously in combination. Various substitutions and modifications may be made by those skilled in the art without departing from the scope of the present disclosure, and all such substitutions and modifications should fall within the scope of the present disclosure.

What is claimed is:

1. An interaction method comprising:
displaying interactive information on a first interface, the interactive information at least including first information input by a user and second information generated by an agent based on the first information;
determining one or more map nodes based on the interactive information and generating an interactive information map based on the one or more map nodes, the information map being displayed on a second interface; and
in response to an operation on the first interface or the second interface, updating the interactive information map and the interactive information on the first interface;
wherein the first interface and the second interface have relatively independent display areas that are able to adaptively scale based on displayed content.

2. The method according to claim 1, wherein determining the one or more map nodes and generating the interactive information map includes:
extracting one or more target keywords based on the first information and the second information;
determining an initial node and one or more branch nodes of the interactive information map based on the one or more target keywords; and
setting interaction attributes for the initial node and the one or more branch nodes to generate the interactive information map.

3. The method according to claim 2, wherein setting the interaction attributes includes:
setting at least one interactive function for the initial node and the one or more branch nodes, the at least one interactive function being used to perform operations on the map nodes; and
setting an association relationship between the initial node or the one or more branch nodes and the interactive information of the first interface.

4. The method according to claim 1, wherein in response to the operation on the second interface, updating the interactive information map and the interactive information on the first interface includes:
in response to the operation on the second interface, updating the interactive information on the first interface; and
adjusting a display state or a node relationship of the interactive information map based on the updated interactive information.

5. The method according to claim 1, wherein in response to the operation on the first interface, updating the interactive information map and the interactive information of the first interface includes:
parsing the first information received on the first interface to determine a target keyword;
mapping the target keyword to one map node of the one or more map nodes and performing an operation on the one map node to obtain an execution result; and
dynamically adjusting the interactive information map based on the execution result.

6. The method according to claim 1, further comprising:
setting a prompt on the first interface or the second interface to guide the user to perform an interactive operation; and
displaying execution progress of the interactive operation on the first interface or the second interface.

7. The method according to claim 1, further comprising:
providing a node backtracking function, to allow the user to return to a previous level node of the information map through an operation; and
providing a global view function, to allow the user to view a global structure of the information map through an operation.

8. The method according to claim 1, further comprising:
highlighting target nodes and hiding or fading all other nodes except the target nodes, the target nodes including a currently executing node and nodes associated with the currently executing node.

9. An electronic device comprising:
one or more processors; and
one or more memories storing executable instructions that, when executed by the one or more processors, cause the electronic device to:
display interactive information on a first interface, the interactive information at least including first information input by a user and second information generated by an agent based on the first information;
determine one or more map nodes based on the interactive information and generate an interactive information map based on the one or more map nodes, the information map being displayed on a second interface; and
in response to an operation on the first interface or the second interface, update the interactive information map and the interactive information on the first interface;
wherein the first interface and the second interface have relatively independent display areas that are able to adaptively scale based on displayed content.

10. The electronic device according to claim 9, wherein the instructions, when executed by the one or more processors, further cause the electronic device to, when determining the one or more map nodes and generating the interactive information map:
extract one or more target keywords based on the first information and the second information;
determine an initial node and one or more branch nodes of the interactive information map based on the one or more target keywords; and
set interaction attributes for the initial node and the one or more branch nodes to generate the interactive information map.

11. The electronic device according to claim 10, wherein the instructions, when executed by the one or more processors, further cause the electronic device to, when setting the interaction attributes:
set at least one interactive function for the initial node and the one or more branch nodes, the at least one interactive function being used to perform operations on the map nodes; and
set an association relationship between the initial node or the one or more branch nodes and the interactive information of the first interface.

12. The electronic device according to claim 9, wherein the instructions, when executed by the one or more processors, further cause the electronic device to, when in response to the operation on the second interface, updating the interactive information map and the interactive information on the first interface:
in response to the operation on the second interface, update the interactive information on the first interface; and
adjust a display state or a node relationship of the interactive information map based on the updated interactive information.

13. The electronic device according to claim 9, wherein the instructions, when executed by the one or more processors, further cause the electronic device to, when in response to the operation on the first interface, updating the interactive information map and the interactive information of the first interface:
parse the first information received on the first interface to determine a target keyword;
map the target keyword to one map node of the one or more map nodes and performing an operation on the one map node to obtain an execution result; and
dynamically adjust the interactive information map based on the execution result.

14. The electronic device according to claim 9, wherein the instructions, when executed by the one or more processors, further cause the electronic device to:
set a prompt on the first interface or the second interface to guide the user to perform an interactive operation; and
display execution progress of the interactive operation on the first interface or the second interface.

15. The electronic device according to claim 9, wherein the instructions, when executed by the one or more processors, further cause the electronic device to:
provide a node backtracking function, to allow the user to return to a previous level node of the information map through an operation; and
provide a global view function, to allow the user to view a global structure of the information map through an operation.

16. The electronic device according to claim 9, wherein the instructions, when executed by the one or more processors, further cause the electronic device to:
highlight target nodes and hiding or fading all other nodes except the target nodes, the target nodes including a currently executing node and nodes associated with the currently executing node.

17. A non-transitory computer-readable storage medium storing instructions that, when executed by a processor, cause an electronic device including the processor to:
display interactive information on a first interface, the interactive information at least including first information input by a user and second information generated by an agent based on the first information;
determine one or more map nodes based on the interactive information and generate an interactive information map based on the one or more map nodes, the information map being displayed on a second interface; and
in response to an operation on the first interface or the second interface, update the interactive information map and the interactive information on the first interface;
wherein the first interface and the second interface have relatively independent display areas that are able to adaptively scale based on displayed content.

18. The storage medium according to claim 17, wherein the instructions, when executed by the one or more processors, further cause the electronic device to, when determining the one or more map nodes and generating the interactive information map:
extract one or more target keywords based on the first information and the second information;
determine an initial node and one or more branch nodes of the interactive information map based on the one or more target keywords; and
set interaction attributes for the initial node and the one or more branch nodes to generate the interactive information map.

19. The storage medium according to claim 18, wherein the instructions, when executed by the one or more processors, further cause the electronic device to, when setting the interaction attributes:
set at least one interactive function for the initial node and the one or more branch nodes, the at least one interactive function being used to perform operations on the map nodes; and
set an association relationship between the initial node or the one or more branch nodes and the interactive information of the first interface.

20. The storage medium according to claim 17, wherein the instructions, when executed by the one or more processors, further cause the electronic device to, when in response to the operation on the second interface, updating the interactive information map and the interactive information on the first interface:
in response to the operation on the second interface, update the interactive information on the first interface; and
adjust a display state or a node relationship of the interactive information map based on the updated interactive information.
